(19) United States
(12) Patent Application Publication
(10) Pub. No.: US 2021/0270348 A1
(43) Pub. Date: Sep. 2, 2021

(54) GEARED ROLLERBOX

(71) Applicant: Genesis Advanced Technology Inc., Surrey (CA)

(72) Inventors: James Brent Klassen, Surrey (CA); Richard Bos, Surrey (CA)

(21) Appl. No.: 17/262,044

(22) PCT Filed: Aug. 1, 2019
(86) PCT No.: PCT/CA2019/051060

§ 371 Date: Jan. 21, 2021

Related U.S. Application Data
(60) Provisional application No. 62/713,232, filed on Aug. 1, 2018.

(51) Int. Cl. F16H 1/28; F16H 13/06

(52) U.S. Cl. CPC F16H 1/28; F16H 13/06; F16H 57/082; F16H 2001/2881; F16H 2001/2872

(57) ABSTRACT

A speed reducer drive can drive an output relative to a fixed ring using planet rollers having different diameter in contact with the output and fixed ring. Elements of the device can be formed of axially arranged segments for ease of construction. Backlash may be removed by manipulation of the drive before tightening segments of the rollers to fix the segments together by friction. The rolling contacts between elements can include a mix of geared contacts for better torque and ungeared contacts to act as bearing surfaces. Geared or ungeared surfaces may be tapered. Elements may be axially adjustable relative to each other, allowing backlash to be removed in combination with taper.

### TECHNICAL FIELD

The invention relates to torque transfer devices, in particular to planetary torque transfer devices.

### BACKGROUND

U.S. Pat. No. 10,174,818 discloses a speed reducer drive driving an output relative to a fixed ring using planet rollers having different diameter in contact with the output and fixed ring. The present disclosure relates to improvements to the devices disclosed in U.S. Pat. No. 10,174,818.

### SUMMARY

There is provided a drive system including an array of planet rollers, each planet roller having a first geared portion having a first diameter and a second geared portion having a second diameter, and an ungeared portion. A fixed outer ring gear is arranged to mesh with the respective first geared portion of each planet roller, and an outer drive or driven ring gear arranged to mesh with the respective second geared portion of each planet roller. A sun is arranged in geared or rolling contact with the planet rollers, the sun and at least one of the fixed outer ring gear and the outer drive or driven ring gear preferably being arranged in rolling contact with the ungeared portion of the planet rollers.

The first geared portion of each planet roller may comprise one or more first geared segments. The second geared portion may comprise one or more second geared segments. The one or more first geared segments and one or more second geared segments may alternate along a length of each respective roller.

The one or more first geared segments may be plural first geared segments, preferably including segments having helical gears of different helical angle.

The one or more second geared segments may be plural second geared segments, preferably including segments having helical gears of different helical angle.

The outer ring drive or driven ring gear may comprise plural outer ring drive or driven gear elements, preferably separated by spacers.

The outer drive or driven ring gear may have corresponding segments, preferably in geared contact with the at least two segments of the first geared portion or of the second geared portion of each roller. The corresponding segments of the outer drive or driven ring gear may be axially adjustable relative to each other.

The fixed outer ring gear may comprise plural fixed outer ring gear elements, preferably separated by spacers.

The fixed outer ring gear may have corresponding segments, preferably in geared contact with the at least two segments of the first geared portion or of the second geared portion of each roller. The corresponding segments of the fixed outer ring gear may be axially adjustable relative to each other.

The sun may comprise plural sun elements, preferably separated by spacers.

The sun may have corresponding segments, preferably in geared contact with the at least two segments of the first geared portion or of the second geared portion of each roller. The corresponding segments of the sun may be axially adjustable relative to each other.

The drive system may be axially symmetric.

The drive system may further comprise a floating sun ring. The floating sun ring may be arranged in geared or rolling contact with the respective second geared portion of each planet roller. The sun may be arranged in geared or rolling contact with the respective first geared portion of each planet roller.

The floating sun ring may be arranged in geared or rolling contact with the respective first geared portion of each planet roller. The sun may be arranged in geared or rolling contact with the respective second geared portion of each planet roller.

The drive system may be arranged as a speed reducer, preferably in which the sun provides an input and the outer driven ring provides an output.

The drive system may be arranged as a speed increaser, preferably in which the sun provides an output and the outer drive ring gear provides an input.

The drive system may further comprise a planet carrier drive element. The planet carrier drive element may be arranged to rotate with the planet rollers around an axis which may be defined by the outer drive or driven ring gear.

The drive system may be arranged as a speed reducer, in which the planet carrier drive element preferably provides an input and the outer driven ring gear provides an output.

The drive system may be arranged as a speed increaser, in which the planet carrier drive element preferably provides an output and the outer drive ring gear provides an input.

The first diameter of the drive system may be greater than the second diameter.

The first diameter of the drive system may be less than the second diameter.

According to another aspect of the present invention, there is provided a drive system including an array of planet rollers, each planet roller having a first geared portion having a first diameter and a second geared portion having a second diameter. Each planet roller is formed of segments arranged axially, the segments secured to rotate together. A fixed outer ring gear is arranged to mesh with the respective first geared portion of each planet roller, and an outer drive or driven ring gear arranged to mesh with the respective second geared portion of each planet roller. A sun is arranged in geared or rolling contact with the planet rollers.

The segments of each planet roller may be secured to a respective axial shaft.

The segments of each planet roller may be secured to a respective axial shaft by axial compression by a bolt on the shaft.

The segments of each planet roller may be formed by extrusion.

Each roller of the drive system may comprise an ungeared portion.

Each segment of each planet roller may correspond to a respective portion of the respective planet roller.

The first geared portion of each planet roller may comprise one or more first geared segments. The second geared portion may comprise one or more second geared segments. The one or more first geared segments and one or more second geared segments may alternate along a length of each respective roller.

The one or more first geared segments may be plural first geared segments, preferably including segments having helical gears of different helical angle.

The one or more second geared segments may be plural second geared segments, preferably including segments having helical gears of different helical angle.

The outer ring drive or driven ring gear may comprise plural outer ring drive or driven gear elements, preferably separated by spacers.

The outer drive or driven ring gear may have corresponding segments in geared contact with the at least two segments of the first geared portion or of the second geared portion of each roller. The corresponding segments of the outer drive or driven ring gear may be axially adjustable relative to each other.

The fixed outer ring gear may comprise plural fixed outer ring gear elements, preferably separated by spacers.

The fixed outer ring gear may have corresponding segments in geared contact with the at least two segments of the first geared portion or of the second geared portion of each roller. The corresponding segments of the fixed outer ring gear may be axially adjustable relative to each other.

The sun may comprise plural sun elements, preferably separated by spacers.

The sun may have corresponding segments in geared contact with the at least two segments of the first geared portion or of the second geared portion of each roller. The corresponding segments of the sun may be axially adjustable relative to each other.

The drive system may be axially symmetric.

The drive system may further comprise a floating sun ring. The floating sun ring may be arranged in geared or rolling contact with the respective second geared portion of each planet roller. The sun may be arranged in geared or rolling contact with the respective first geared portion of each planet roller.

The floating sun ring may be arranged in geared or rolling contact with the respective first geared portion of each planet roller. The sun may be arranged in geared or rolling contact with the respective second geared portion of each planet roller.

The drive system may be arranged as a speed reducer in which the sun provides an input and the outer driven ring provides an output.

The drive system may be arranged as a speed increaser in which the sun provides an output and the outer drive ring gear provides an input.

The drive system may further comprise a planet carrier drive element. The planet carrier drive element may be arranged to rotate with the planet rollers around an axis which may be defined by the outer drive or driven ring gear.

The drive system may be arranged as a speed reducer in which the planet carrier drive element provides an input and the outer driven ring gear provides an output.

The drive system may be arranged as a speed increase in which the planet carrier drive element provides an output and the outer drive ring gear provides an input.

The first diameter may be greater than the second diameter.

The first diameter may be less than the second diameter.

According to another aspect of the present invention, there is provided a drive system including rollers, each roller having first portions of a first diameter and a second portion of a second diameter. A first fixed outer ring and a second fixed outer ring are arranged in rolling contact with the respective first portions of each roller, the fixed outer ring and second fixed outer ring being arranged symmetrically one on each side of the outer drive or driven ring. An outer drive or driven ring is arranged in rolling contact with the respective second portion of each roller. Either at least the first portion of each roller is tapered or at least the second portion of each roller is tapered.

The first portion and the second portion of each planet roller may be tapered.

The second portion of each planet roller may comprise axially symmetric tapered surfaces or gears.

The outer drive or driven ring may comprise axially symmetric components, preferably in rolling contact with the axially symmetric tapered surfaces of the second portion of each planet roller.

The fixed outer ring and second fixed outer ring may be connected to each other, preferably via an axial through hole of the drive system.

The drive system may comprise a sun drive, preferably arranged in rolling contact with the planet rollers.

The second portion of each planet roller may comprise axially symmetric tapered surfaces or gears. The sun drive may comprise axially symmetric components, preferably in rolling contact with the axially symmetric tapered surfaces of the second portion of each planet roller.

The drive system may be arranged as a speed reducer in which the sun drive provides an input and the outer driven ring provides an output.

The drive system may be arranged as a speed increaser in which the sun drive provides an output and the outer drive ring provides an input.

The drive system may further comprise a floating sun. The floating sun may be arranged in rolling contact with the respective second portion of each planet roller. The sun drive may be arranged in rolling contact with the respective first portion of each planet roller.

The drive system may further comprise a floating sun. The floating sun may be arranged in rolling contact with the respective first portion of each planet roller. The sun drive may be arranged in rolling contact with the respective second portion of each planet roller.

The drive system may further comprise a planet carrier drive element. The planet carrier drive element may be arranged to rotate with the planet rollers around an axis which may be defined by the outer drive or driven ring.

The drive system may be arranged as a speed reducer in which the planet carrier drive element provides an input and the outer driven ring provides an output.

The drive system may be arranged as a speed increaser in which the planet carrier drive element provides an output and the outer drive ring provides an input.

The drive system may further comprise a first floating sun, preferably arranged in rolling contact with the respective first portion of each planet roller. The drive system may further comprise a second floating sun, preferably arranged in rolling contact with the respective second portion of each planet roller.

The first diameter may be greater than the second diameter.

The first diameter may be less than the second diameter.

The first portions of each planet roller may be geared. Elements in rolling contact with the first portions may be geared.

The second portions of each planet roller may be geared. Elements in rolling contact with the second portions may be geared.

According to a further aspect of the present invention there is provided a method of manufacturing a drive system according to the present disclosure, comprising the steps of:

providing a, preferably non-transitory, computer-readable storage medium having data thereon representing a three-dimensional model suitable for use in manufacturing a drive system according to the present disclosure; and manufacturing a drive system according to the present disclosure using instructions contained in the three-dimensional model.

An additive manufacturing process, such as 3D printing, may be utilised to manufacture one or more elements of a drive system according to the present disclosure.

According to a further aspect of the present invention, there is provided a computer-readable storage medium, preferably a non-transitory computer-readable storage medium, having data thereon representing a three-dimensional model suitable for use in manufacturing a drive system according to the present disclosure.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a cutaway isometric view of an exemplary roller drive.

FIG. 2 is another cutaway isometric view of the roller drive of FIG. 1, showing exemplary an exemplary construction of roller drive components using axially oriented layers.

FIG. 3 is an exemplary pinion for the roller drive of FIG. 1.

FIG. 4 is a cutaway side view of a further exemplary roller drive.

FIG. 5 is an isometric view of the roller drive of FIG. 4 with an axial plate of the housing removed.

FIG. 6 is a view corresponding to the view of FIG. 5 but with two planets also removed.

FIG. 7 is a view corresponding to the view of FIG. 5 but also with a side cutaway plane.

FIG. 8 shows an axial cutaway view of the roller drive of FIG. 4 with all but one planets removed.

FIG. 9 shows another axial cutaway view of the roller drive of FIG. 4 with all but one planets removed.

FIG. 10 shows a side view with the cut plane of FIG. 8 marked.

FIG. 11 shows a side view with the cut plane of FIG. 9 marked.

FIG. 12 shows an embodiment of a roller drive having a planet carrier and free spinning sun rings.

### DETAILED DESCRIPTION

In an embodiment there is disclosed an apparatus for transmitting power through circular motion while providing the option of a high rotational speed ratio as well as torque multiplication that is approximately proportional to the rotational speed ratio (save minus various losses such as friction). A preferred embodiment transfers torque from the fixed member(s) to the output member(s) via the planet rollers and sun roller input. The device can also be constructed with a hollow sun roller for cable access in applications such as robotic and bionic joints.

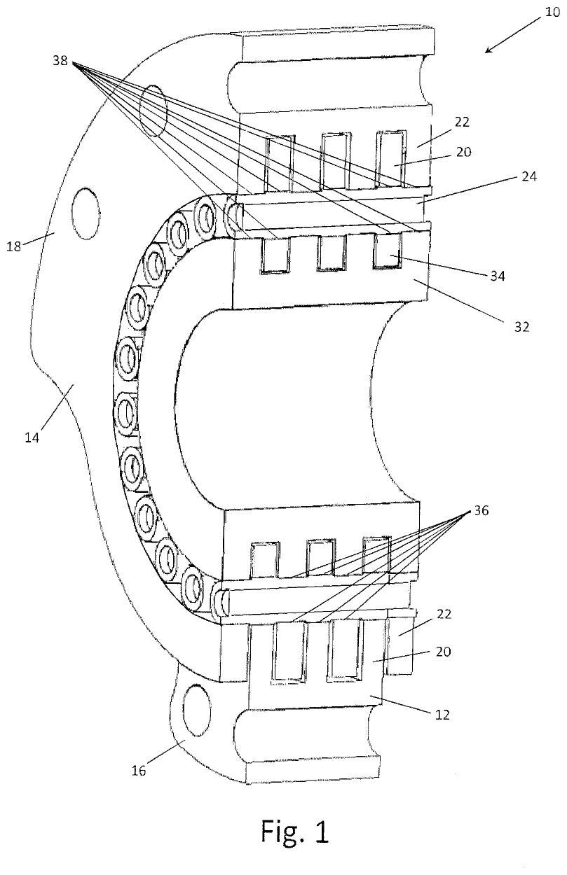

An embodiment of a roller drive 10 is shown in FIGS. 1-3. The embodiment has a fixed housing member 12 and an output housing member 14. In the embodiment shown, the output housing member 14 has an output flange 18 for connecting to an output, and the fixed housing member 12 has a fixed flange 16 for connecting to some object or structure (not shown) relative to which the output is to be driven. The flanges 16, 18 are each connected to plural rings, the fixed flange 16 being connected to fixed rings 20 of the fixed housing member 12 and the output flange 18 being connected to output rings 22 of the output housing member 14. There can be different numbers of rings than shown, and one or both of the output and fixed housing members may also have as few as one ring. The plural rings on both housing members, where present, assist with axial alignment of components. In the embodiment shown, the fixed flange 16 and output flange 18 are limited in the range of relative rotational motion by interference between the flanges. In the embodiment shown, the axially outermost rings are output rings 22 of the output housing member 14, but alternatively the axially outermost rings could be fixed rings 20 of the fixed housing member 12. In a further alternative, a ring furthermost in one axial direction could be a ring of one axial member and a ring furthermost in another axial direction could be a ring of another axial member. In a preferred embodiment, as shown, the arrangement of rings is symmetrical under reflection in the axial direction.

The fixed rings 20 and the output rings 22 engage with planets 24, also referred to in this document as pinions. The pinons 24 comprise portions 30 adjacent to different components or contacting the same components via different means (e.g. geared v. traction). The portions adjacent to the output rings 22 have different diameter than the portions adjacent to the fixed rings 20, so that planetary motion of the planets 24 drives the output rings 22 relative to the fixed rings 20. In this document, “diameter” refers to pitch diameter for geared portions of the planets and rolling diameter for traction portions. Either portion may be smaller than the other; reversing which one is smaller reverses the direction of motion of the output.

Input to the roller drive 10 may be provided by a sun 32. The sun may engage with the portions of the pinions that engage with the output rings, or it may engage with the portions of the pinions that engage with the fixed rings. In the embodiment shown, the sun 32 engages with the portions of the pinions that engage with the output rings, which are, also in this embodiment, smaller in diameter than the portions of the pinions that engage with the fixed rings. One or more floating sun rings 34 may be provided to engage with portions of the pinions that do not engage with the sun 32. The floating sun rings 34 are provided to reduce twisting forces on the planets but can be omitted.

Preferably, at least one of the fixed rings 20 is geared, and at least one of the output rings 22 is geared, and the geared rings mesh with corresponding geared portions of the pinions. This enables the roller drive 10 to handle higher torque than with traction surfaces. In the embodiment shown, there are geared interfaces 36 at the axially innermost fixed ring and the two axially innermost output rings. In the embodiment shown, axially outer rings and pinion portions have traction interfaces 38. The traction surfaces act as roller bearings for an integrated reducer/bearing.

The sun 32 can interface with the pinions 24 via geared or traction surfaces or both. If the sun 32 interfaces with the pinions 24 using geared surfaces on at least one set of the portions of the pinions, and at least one of the fixed housing member and output housing member also have geared interfaces with the pinions, the geared interfaces can together space the pinions 24 so that no planet carrier is needed to space the gears circumferentially.

Where a pinion has a geared surface, typically all mating surfaces will be geared, and where a pinion has a traction surfaces, typically all mating surfaces will be traction surfaces.

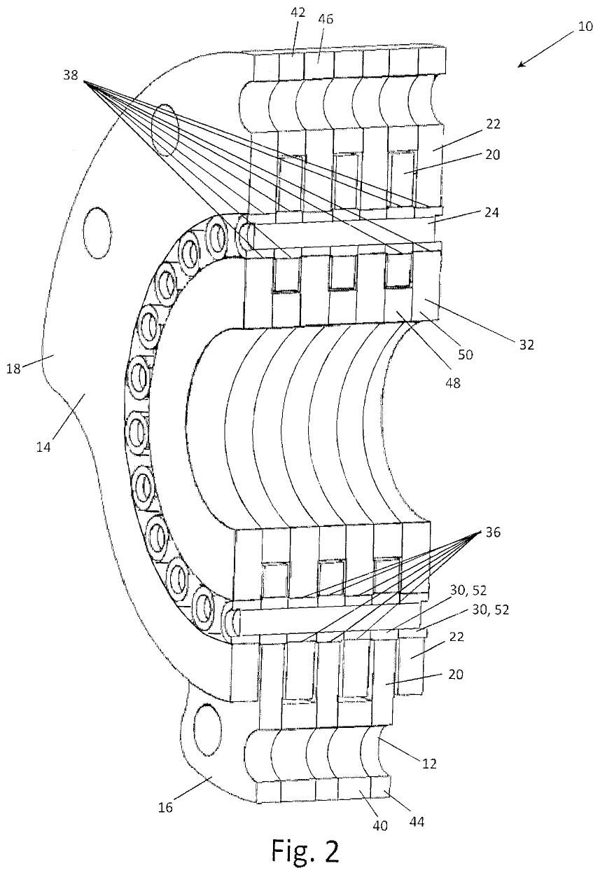

For ease of construction, the fixed flange 16 may be formed using fixed housing member spacers 40 arranged between extensions 44 of the fixed rings 20, and the output flange 18 may be formed using output housing member spacers 42 arranged between extensions 46 of the fixed rings 22, as shown in FIG. 2. Likewise, the sun 32 may for simplicity of construction be formed using spacers 48 arranged between sun rings 50.

For simplicity of construction, the pinions 24 may be formed in segments 52.

Shims may also be placed between axially spaced components to adjust axial positioning of elements as described further in relation to FIGS. 4-11. The spacers 40, 42, 48 may optionally have selectable width so as to act as shims. Gear and bearing surfaces may also optionally be axially tapered as further described in relation to FIGS. 4-11.

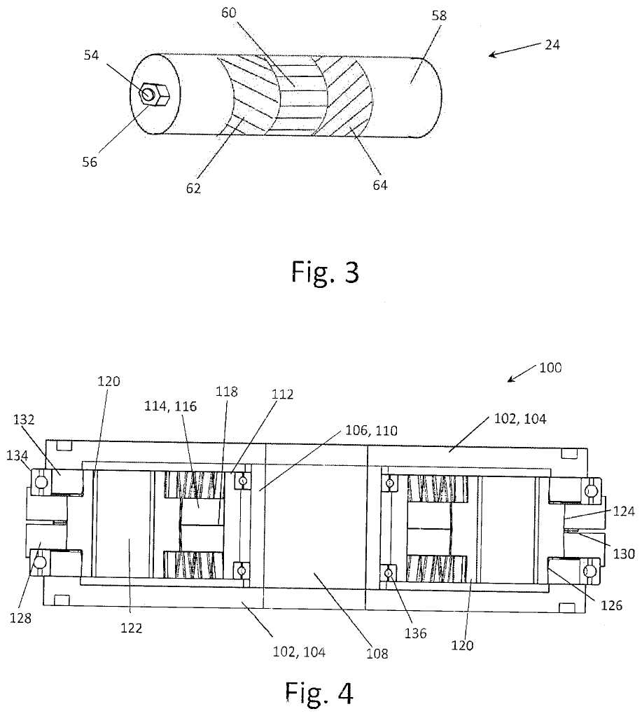

As shown in FIG. 3, the segments 52 may be fixed together on a common shaft 54 such that each pinion can act as one component. For example, a bolt 56 may be used to apply axial compression to the segments 52 to cause the segments to move as one component due to friction between the segments 52. The segments 52 can be manufactured by low cost means such as by extrusion. The segments 52 may for example, as shown in FIG. 2, respectively correspond to the portions of different diameter described above. Differences in diameter are not shown in FIG. 3 but would be present. When bolting the segments 52 together on a pinion, one or more portions of the pinion having geared surfaces can be biased in the opposite rotational direction to take up backlash. This can be done for example by rotating the actuator in one direction while tightening the through-bolt on half of the pinions, and rotating the opposite direction while tightening the thru-bolts on the other half of the pinions.

Helical gears, for example, may be used. In an embodiment, symmetrically opposing portions may have gears of opposite helical angle for a herringbone effect that provides axial centering without a planet carrier. FIG. 3 shows a pinion 24 with an exemplary arrangement of gears on the portions of the pinion 24. At the ends are bearing surfaces 58 with no gear teeth. At the axial center is a center gear surface 60 which may include straight or helical gears. On opposite sides of the center are helical gear surfaces 62 and 64, the gear surfaces 62 and 64 having helical gears of opposite winding.

The roller drive 10 described above may be combined with an electric motor (not shown) connected to the sun 32.

The above description is for a roller drive with fixed and output ring gears, and a sun input. Which of the housing members is “fixed” and which is an “output” is relative, and a description or claim including a first housing member being fixed and a second housing member being an output also includes the second housing member being fixed and the first housing member being an output.

With the same structure as shown, the roller drive 10 can also be used as a speed increaser, with a sun output and input and fixed housing members. The drive could also be turned radially inside out, as a speed reducer with output and fixed sun members and an outer ring input, or as a speed increaser with input and fixed sun members and an outer ring output.

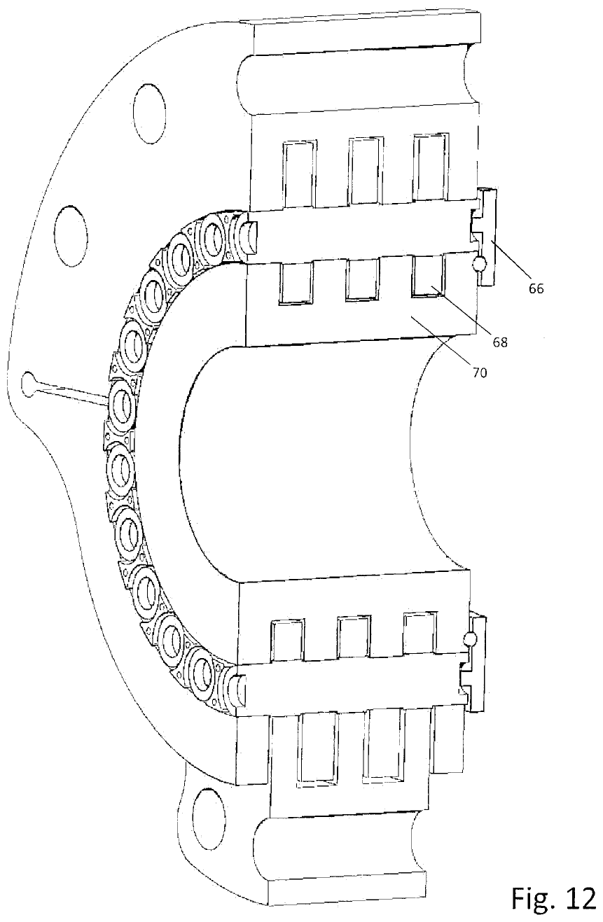

FIG. 12 shows an embodiment of a roller drive having a planet carrier 66 and floating sun gears 68. Optionally, the planet carrier 66, rather than the sun 70, can serve as an input to the planets. In this case, the sun 70 is an additional floating sun. The planet carrier is arranged to rotate with the planet rollers around an axis defined by drive system, for example by the outer drive or driven ring.

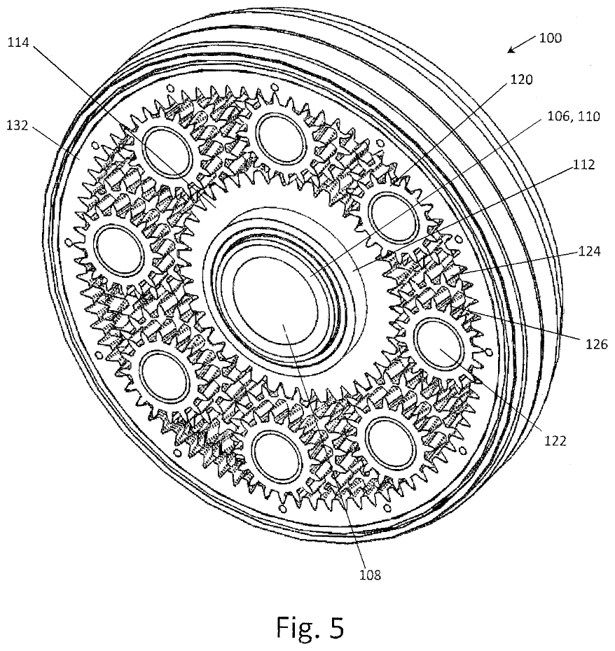

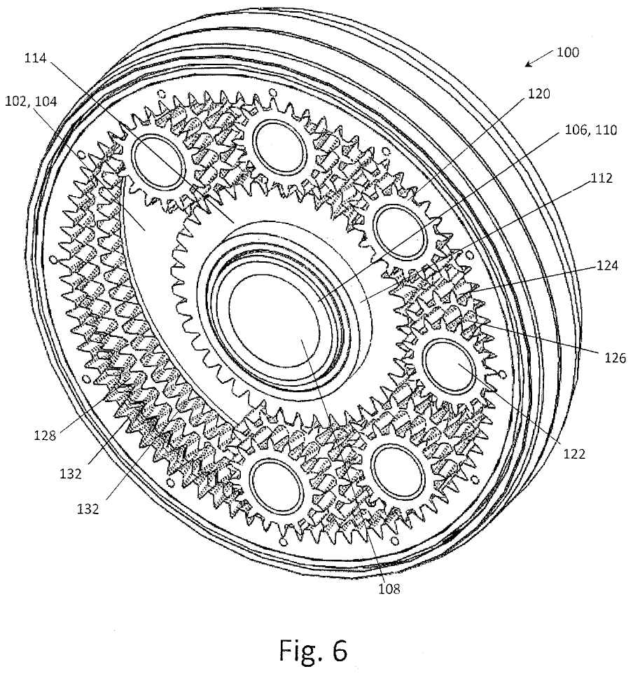

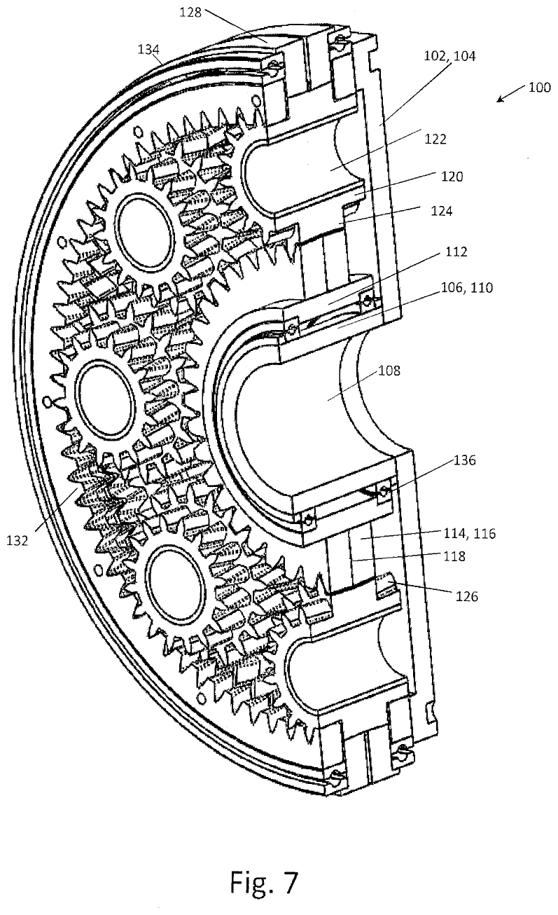

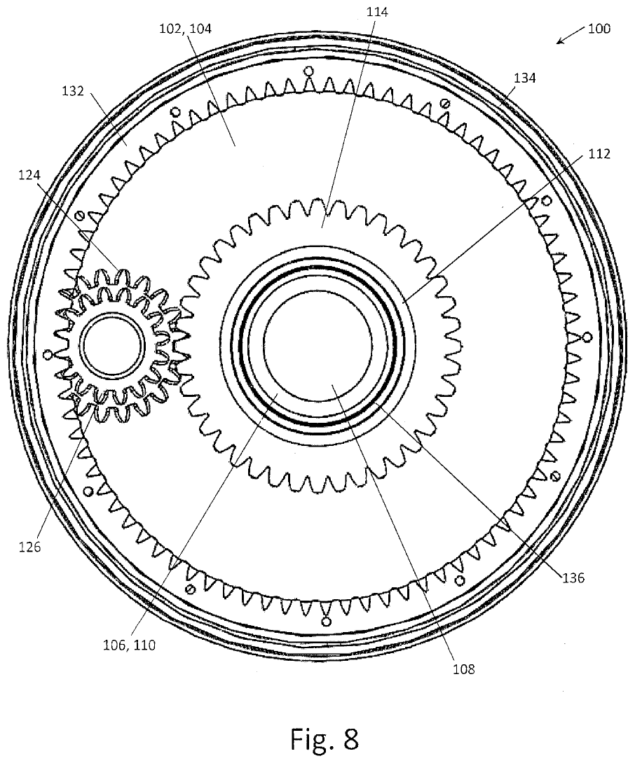

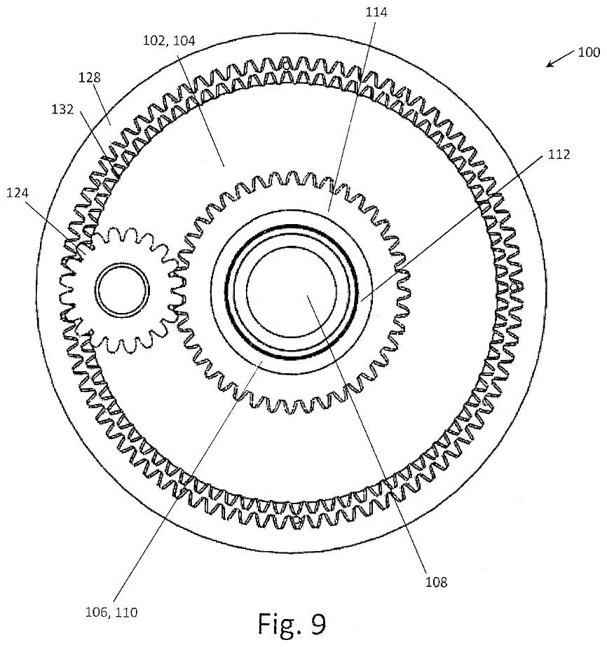

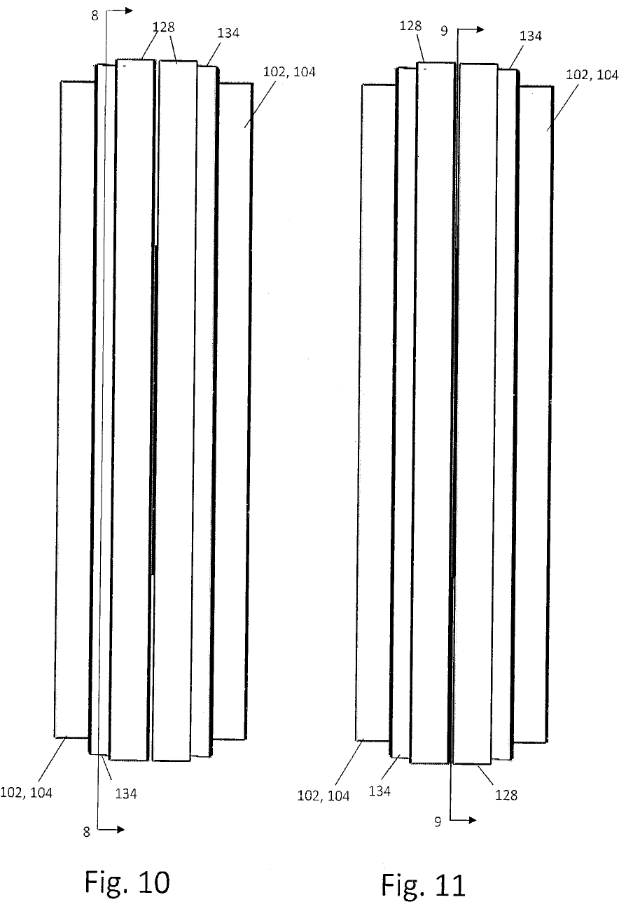

FIGS. 4-11 show a roller drive 100 having an integrated electric motor and tapered gears. FIG. 4 shows a cutaway side view, FIG. 5 shows an isometric view with an axial plate of the housing removed, and FIG. 6 shows the view of FIG. 5 with two planets also removed. FIG. 7 shows the view of FIG. 5 with a side cutaway plane. FIG. 8 shows an axial cutaway view with all but one planets removed, and FIG. 9 shows another axial cutaway view with all but one planets removed. FIG. 10 shows a side view with the cut plane of FIG. 8 marked, and FIG. 11 shows a side view with the cut plane of FIG. 9 marked.

As shown in FIG. 4, the roller drive 100 has a housing 102 that includes axial plates 104 connected by a radially inner housing surface 106 defining an axial through hole 108. In this embodiment the radially inner housing surface includes a stator 110 of an electric motor. A rotor 112 of the electric motor is driven by the stator and connects to a sun gear 114. The sun gear is formed of two tapered portions 116 separated axially by a shim 118. The sun gear meshes with planets 120. The planets 120 may be formed from multiple segments. This may be achieved in the manner shown in FIGS. 1-3, but in this embodiment the planets 120 are each formed as one piece having an axial through hole 122. The gears of the planet 120 in this embodiment include axially center gears 124 and axially outside gears 126. As shown the axially center gears 124 mesh with the sun gear 114, but the sun gears could alternatively be further spaced to mesh with the axially outside gears 126.

The axially center gears 124 mesh with output ring gears 128. The output ring gears 128 may be separated by a shim 130. Fixed ring gears 132 are connected to axial plates 104, and mesh with the axially outside gears 126. In the embodiment shown the axially outside gears 126 are tapered, at a lesser angle than the taper of the axially center gears 124.

All gears meshing with a tapered gear may have a taper corresponding to and opposite to that of the tapered gear.

The axially adjustable shims can be used in combination with the axial taper to eliminate backlash clearance. Shims may be applied to adjust relative axial position of any of the elements relative to the axial center plane or each other. To maintain symmetry, it would generally not be desirable to change the axial position of elements that straddle the center plane.

The axially center gears 124 are of different diameter than the axially outside gears 126 to cause differential movement of the output ring gears 128 and fixed ring gears 132.

In the embodiment shown output bearings 134 are optionally provided between the output ring gears 128 and fixed ring gears 132, and input bearings 136 are optionally provided between the rotor 112 and stator 110.

The motor can also be used as a generator, in which case the output ring gears 128 provide an input to the roller drive and the sun gear 114 provides an output of the roller drive to turn the generator.

In FIG. 10, the line labeled 8 indicates the cutaway plane of FIG. 8, and in FIG. 11, the line labeled 9 indicates the cutaway plane of FIG. 9.

Any of the embodiments of the drive system and/or its components described herein may be manufactured by automated manufacturing means and methods. Such means and methods include material removal techniques and additive manufacturing techniques and systems, also known as 3D-printing. Such techniques generally require a computer readable model of the product to be manufactured to be created and from that virtual 3D model, a computer can derive a set of instructions to instruct a material removal system such as a computer controlled machining centre, or an additive manufacturing system such as a 3D printer, to manufacture the product. A skilled person will be aware of such systems and so the detail of their functioning is not described here in detail. Different materials having different properties can be better suited to either additive manufacture or material removal techniques, but both generally start from a 3D model and generate instructions from the model to control a 3D printer or material removal device (often called a CNC—computer numerically controlled—machining device). Such devices are widely available and are not described herein in the interests of efficiency, but will be well known to the person skilled in such manufacturing techniques and apparatus. Suitable 3D models for generating manufacturing instructions can be general 3D CAD (computer aided design) files and can be considered a computer program product suitable for generating instructions for the manufacture of the product. Such models can be interpreted by, or adapted for, 3D printing software, CNC software, or a 3D printer device, in order to manufacture the product.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1-20. (canceled)

21. A drive system comprising:
an array of planet rollers, each planet roller having a first geared portion having a first diameter and a second geared portion having a second diameter, each planet roller being formed of segments arranged axially, the segments secured to rotate together;
a fixed outer ring gear arranged to mesh with the respective first geared portion of each planet roller;
an outer drive or driven ring gear arranged to mesh with the respective second geared portion of each planet roller; and
a sun arranged in geared or rolling contact with the planet rollers.

22. The drive system of claim 21 in which the segments of each planet roller are secured to a respective axial shaft.

23. (canceled)

24. (canceled)

25. The drive system of claim 21 in which each roller comprises an ungeared portion.

26. (canceled)

27. The drive system of claim 21 in which the first geared portion of each planet roller comprises one or more first geared segments and the second geared portion comprises one or more second geared segments, the one or more first geared segments and one or more second geared segments alternating along a length of each respective roller.

28. The drive system of claim 27 in which the one or more first geared segments are plural first geared segments including segments having helical gears of different helical angle.

29. The drive system of claim 27 in which the one or more second geared segments are plural second geared segments including segments having helical gears of different helical angle.

30-36. (canceled)

37. The drive system of claim 21 further comprising a floating sun ring arranged in geared or rolling contact with the respective second geared portion of each planet roller, the sun being arranged in geared or rolling contact with the respective first geared portion of each planet roller.

38. The drive system of claim 21 further comprising a floating sun ring arranged in geared or rolling contact with the respective first geared portion of each planet roller, the sun being arranged in geared or rolling contact with the respective second geared portion of each planet roller.

39. The drive system of claim 21 arranged as a speed reducer in which the sun provides an input and the outer driven ring provides an output.

40. The drive system of claim 21 arranged as a speed increaser in which the sun provides an output and the outer drive ring gear provides an input.

41. (canceled)

42. The drive system of claim 21 further comprising a planet carrier drive element arranged to rotate with the planet rollers around an axis defined by the outer drive or driven ring gear, wherein the drive system is arranged as a speed reducer in which the planet carrier drive element provides an input and the outer driven ring gear provides an output.

43. The drive system of claim 21 further comprising a planet carrier drive element arranged to rotate with the planet rollers around an axis defined by the outer drive or driven ring gear, wherein the drive system is arranged as a speed increaser in which the planet carrier drive element provides an output and the outer drive ring gear provides an input.

44. (canceled)

45. (canceled)

46. A drive system comprising:
an array of planet rollers, each planet roller having first portions of a first diameter and a second portion of a second diameter;
a first fixed outer ring and a second fixed outer ring arranged in rolling contact with the respective first portions of each planet roller, the first fixed outer ring and second fixed outer ring being arranged symmetrically one on each side of the outer drive or driven ring;
an outer drive or driven ring arranged in rolling contact with the respective second portion of each planet roller; and
either at least the first portion of each planet roller being tapered or at least the second portion of each planet roller being tapered.

47. (canceled)

48. The drive system of claim 46 in which the second portion of each planet roller comprises axially symmetric tapered surfaces or gears.

49-52. (canceled)

53. The drive system of claim 46, in which the drive system comprises a sun drive arranged in rolling contact with the planet rollers and the drive system is arranged as a speed reducer in which the sun drive provides an input and the outer driven ring provides an output.

54. The drive system of claim 46, in which the drive system comprises a sun drive arranged in rolling contact with the planet rollers and the drive system is arranged as a speed increaser in which the sun drive provides an output and the outer drive ring provides an input.

55. The drive system of claim 46 further comprising a floating sun arranged in rolling contact with the respective second portion of each planet roller, the sun drive being arranged in rolling contact with the respective first portion of each planet roller.

56. The drive system of claim 46 further comprising a floating sun arranged in rolling contact with the respective first portion of each planet roller, the sun drive being arranged in rolling contact with the respective second portion of each planet roller.

57. (canceled)

58. The drive system of claim 46 further comprising a planet carrier drive element arranged to rotate with the planet rollers around an axis defined by the outer drive or driven ring, and wherein the drive system is arranged as a speed reducer in which the planet carrier drive element provides an input and the outer driven ring provides an output.

59. The drive system of claim 46 further comprising a planet carrier drive element arranged to rotate with the planet rollers around an axis defined by the outer drive or driven ring, and wherein the drive system is arranged as a speed increaser in which the planet carrier drive element provides an output and the outer drive ring provides an input.

60. The drive system of claim 46 further comprising a planet carrier drive element arranged to rotate with the planet rollers around an axis defined by the outer drive or driven ring, and further comprising a first floating sun arranged in rolling contact with the respective first portion of each planet roller and a second floating sun arranged in rolling contact with the respective second portion of each planet roller.

61-66. (canceled)

67. A non-transitory computer-readable storage medium having data thereon representing a three-dimensional model suitable for use in manufacturing a drive system according to claim 21.
